(19) United States
(12) Patent Application Publication
(10) Pub. No.: US 2023/0230007 A1
(43) Pub. Date: Jul. 20, 2023

(54) SYSTEMS AND METHODS FOR PREDICTIVE HOLISTIC FACILITY MANAGEMENT

(71) Applicant: NUFAM LLC, Fort Worth, TX (US)

(72) Inventors: Blaine E. Sibby, Fort Worth, TX (US); David Leslie, Roanoke, TX (US)

(73) Assignee: NUFAM LLC, Fort Worth, TX (US)

(21) Appl. No.: 18/156,162

(22) Filed: Jan. 18, 2023

Related U.S. Application Data
(60) Provisional application No. 63/300,992, filed on Jan. 19, 2022.
(60) Provisional application No. 63/344,616, filed on May 22, 2022.

(51) Int. Cl. G06Q 10/0635

(52) U.S. Cl. CPC G06Q 10/0635

(57) ABSTRACT

A system for predictive holistic facility management is provided including a sensor in electronic communication with a processor, a non-transitory computer-readable storage medium in electronic communication with the processor having instructions stored thereon that, in response to execution by the processor, cause the processor to perform operations comprising, receiving, at the processor, first data related to a building from the sensor, receiving, at the processor, second data related to a state of the building, calculating, by the processor, a PC Ratio of the building based upon the first data and the second data, and/or allocating, by the processor, a predetermined capital expenditure and operating expenditure budget to the building based upon the PC Ratio.

### CROSS-REFERENCE TO RELATED APPLICATIONS

This application claims priority to, and is a nonprovisional of, U.S. Provisional Application No. 63/300,992 entitled “SYSTEMS AND METHODS FOR PREDICTIVE HOLISTIC FACILITY MANAGEMENT” filed on Jan. 19, 2022. This application claims priority to, and is a nonprovisional of, U.S. Provisional Application No. 63/344,616, entitled “SYSTEMS AND METHODS FOR PREDICTIVE HOLISTIC FACILITY MANAGEMENT” filed on May 22, 2022. The contents of the aforementioned '992 application and '616 application are hereby incorporated by reference herein for any purpose FIELD

The present disclosure generally relates to buildings, and in particular to systems and methods for predictive maintenance in buildings.

### BACKGROUND

Traditional aspects of constructing, managing, and owning a building can be disjointed. For example, eighty percent of new construction litigation may arise from water intrusion. Ninety percent of such leaks occur in less than one percent of the building surface. Often, such leaks occur at interfaces where systems connect because different trades are relied upon to manage these interfaces. Upon commissioning of a building, the need for construction continues in the form of maintenance. Because a typical life cycle for a structure or components therein is often over a decade, the ongoing maintenance operations are often forgotten. Accordingly, performance of the building may tend to be degraded from the originally specified structure. A system to integrate construction requirements and maintenance operations is therefore desirable to ensure performance over the lifecycle of the structure.

### SUMMARY

In various embodiments, systems, methods, and articles of manufacture (collectively, the “system”) for predictive holistic facility management are disclosed.

Disclosed herein in various embodiments is a system for predictive holistic facility management including a sensor in electronic communication with a processor, a non-transitory computer-readable storage medium in electronic communication with the processor having instructions stored thereon that, in response to execution by the processor, cause the processor to perform operations comprising, receiving, at the processor, first data related to a building from the sensor, receiving, at the processor, second data related to a state of the building, calculating, by the processor, a PC Ratio of the building based upon the first data and the second data, and allocating, by the processor, a predetermined capital expenditure and operating expenditure budget to the building based upon the PC Ratio.

Disclosed herein in various embodiments is a method for predictive holistic facility management including receiving, at a processor, first data related to a building from a sensor, receiving, at the processor, second data related to a state of the building, calculating, by the processor, a PC Ratio of the building based upon the first data and the second data, and allocating, by the processor, a predetermined capital expenditure and operating expenditure budget to the building based upon the PC Ratio.

Disclosed herein is an article of manufacture including a tangible, non-transitory computer-readable storage medium in electronic communication with a processor system, having instructions stored thereon that, in response to execution by a processor, cause the processor to perform operations comprising receiving, at the processor, first data related to a building from a sensor, receiving, at the processor, second data related to a state of the building, calculating, by the processor, a PC Ratio of the building based upon the first data and the second data, and allocating, by the processor, a predetermined capital expenditure and operating expenditure budget to the building based upon the PC Ratio.

The features and elements may be combined in various combinations without exclusivity, unless expressly indicated herein otherwise. These features and elements as well as the operation of the disclosed embodiments will become more apparent in light of the following description and accompanying drawings. The contents of this section are intended as a simplified introduction to the disclosure, and are not intended to limit the scope of any claim.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements. The patent or application file contains at least one drawing executed in color. Copies of this patent or patent application publication with color drawing(s) will be provided by the Office upon request and payment of the necessary fee.

FIG. 1 is a block diagram illustrating various system components of a predictive holistic facility management system, in accordance with various embodiments.

FIG. 2 is a block diagram illustrating a service of a predictive holistic facility management system, in accordance with various embodiments;

FIG. 3 illustrates a property portfolio page of a predictive holistic facility management system, in accordance with various embodiments.

FIG. 4 illustrates a property management dashboard of a predictive holistic facility management system, in accordance with various embodiments.

FIG. 5 illustrates a subsystem status page of a predictive holistic facility management system, in accordance with various embodiments.

FIG. 6 illustrates example parametric equations and sensor data for status decisions in a predictive holistic facility management system, in accordance with various embodiments.

FIG. 7 illustrates a block diagram illustrating various system components of a predictive holistic facility management system, in accordance with various embodiments.

FIG. 8 illustrates a method of use of a predictive holistic facility management system, in accordance with various embodiments.

FIG. 9 illustrates a method of use of a predictive holistic facility management system, in accordance with various embodiments.

FIG. 10 illustrates a method of use of a predictive holistic facility management system, in accordance with various embodiments.

FIG. 11 illustrates a method of use of a predictive holistic facility management system, in accordance with various embodiments.

FIG. 12 illustrates a method of use of a predictive holistic facility management system, in accordance with various embodiments.

FIG. 13 illustrates a method of use of a predictive holistic facility management system, in accordance with various embodiments.

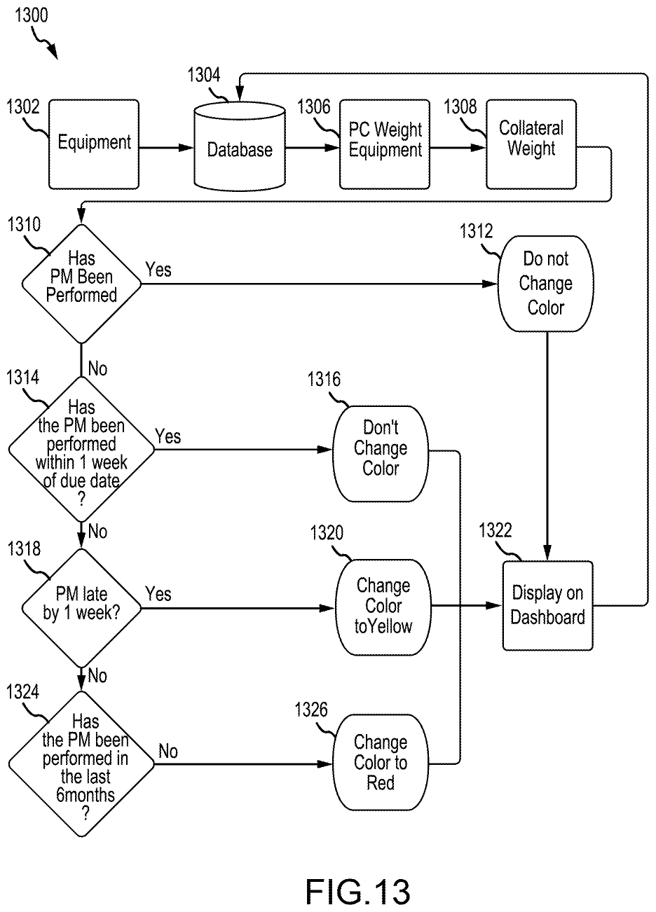

FIG. 14 illustrates a method of use of a predictive holistic facility management system, in accordance with various embodiments,

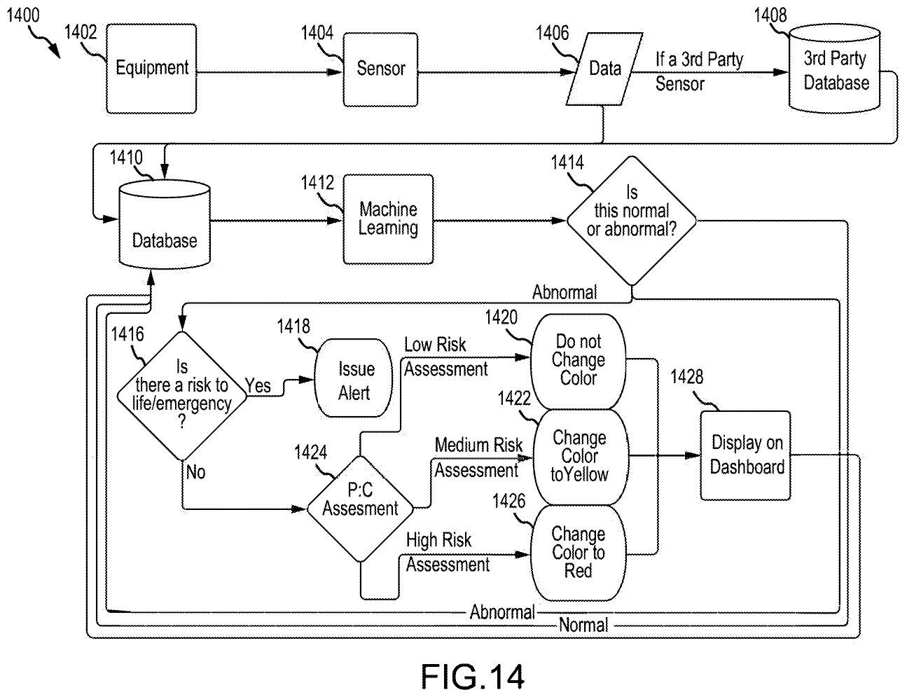

FIG. 15 illustrates a method of use of a predictive holistic facility management system, in accordance with various embodiments.

FIG. 16 illustrates a method of displaying data in a predictive holistic facility management system, in accordance with various embodiments.

### DETAILED DESCRIPTION

The following description is of various exemplary embodiments only, and is not intended to limit the scope, applicability, or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for mobile device application design and implementation, as well as conventional mobile device communications techniques, interface elements, and so forth, and/or the like, may not be described in detail herein. Furthermore, the connecting lines shown in various figures contained herein are intended to represent exemplary functional relationships and/or physical or communicative couplings between various elements. It should be noted that many alternative or additional functional relationships or communicative connections may be present in a practical system or related methods of use, for example a system for predictive holistic facility management.

As used herein, Computer Maintenance Management System (CMMS) refers to any software that maintains a database of information about an organization's maintenance operations. This information is intended to help maintenance workers do their jobs more effectively (for example, determining which machines require maintenance and which storerooms contain which spare parts) and to help management make informed decisions (for example, calculating the cost of machine breakdown repair versus preventive maintenance for each machine, possibly leading to better allocation of resources).

As used herein, Performance to Comfort Ratio (also referred to as P:C Ratio or PC Ratio) refers to a formula designed to weigh the difference between the true costs of a system's failure in the building where it functions. Performance ratings are derived from the replacement cost (today's value or projected value) plus the collateral damage created throughout the building due to its failure. Comfort ratings are derived from the value of revenue generating square footage affected by a system's failure in the building where it functions.

As used herein, Preventative Maintenance (PM) refers to routinely scheduled and performed on equipment, systems and assets to reduce failure, and ensure they meet their estimated useful life.

As used herein, Estimated Useful Life (EUL) refers to the average anticipated lifespan of property, plant or equipment.

As used herein, Capital expenditures (CAPEX) refers to funds used by a company to acquire, upgrade, and maintain physical assets such as property, plants, buildings, technology, or equipment. CapEx is often used to undertake new projects or investments by a company. Making capital expenditures on fixed assets can include repairing a roof (if the useful life of the roof is extended), purchasing a piece of equipment, or building a new factory. This type of financial outlay is made by companies to increase the scope of their operations or add some future economic benefit to the operation.

As used herein, operating expense (OPEX) refers to an expense a business incurs through its normal business operations. Often abbreviated as OPEX, operating expenses include rent, equipment, inventory costs, marketing, payroll, insurance, step costs, and funds allocated for research and development. Maintenance and repair are additional operating expenses.

As used herein, collateral damage refers to the cost of damage incurred by the failure of a piece of equipment or system to the surrounding structure or its components.

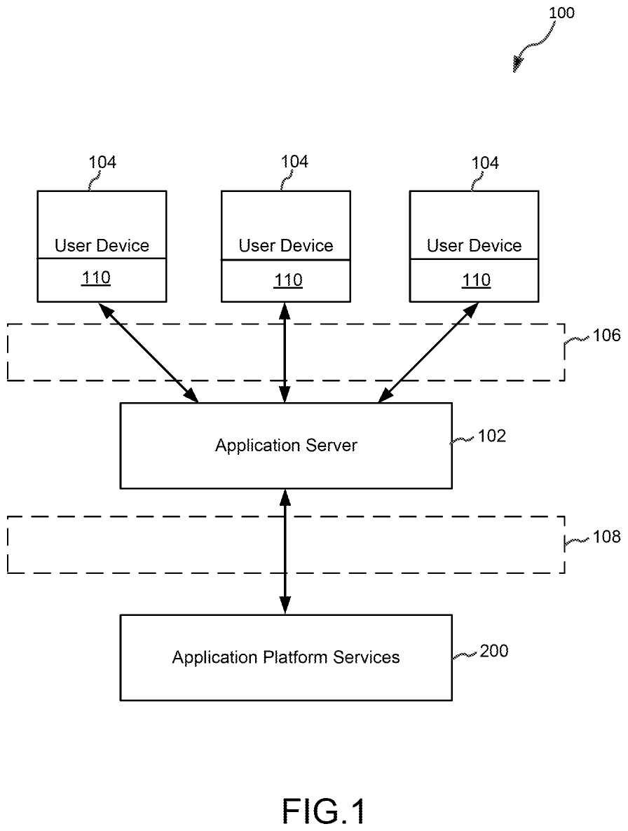

In various embodiments, and with reference now to FIG. 1, a system 100 may comprise an application server 102, a user device 104, and an application services platform 200. Any of these components may be outsourced and/or be in communication with the data comparator application server 102 and/or platform 200 via a network such as, for example a first network 106 and a second network 108.

System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. In various embodiments, the application server 102 and/or platform 200 may be configured as a central network element or hub to access various systems, engines, and components of system 100. The application server 102 may comprise a network (e.g., network 106), a computer-based system, and/or software components configured to provide an access point to various systems, engines, and components of system 100. The application server 102 may be in operative and/or electronic communication with user devices 104 via the first network 106 and the platform 200 via the second network 108. In this regard, the application server 102 may allow communication from the user devices 104 to systems, engines, and components of system 100 (such as, for example, platform 202). In various embodiments, the application server 102 may receive commands and/or metadata from the user devices 104 and may pass replies to the user devices 104.

In various embodiments, application server 102 may include one or more computing devices described above, rack mounted servers, and/or virtual machines providing load balancing, application services, web services, data query services, data transfer services, reverse proxy services, or otherwise facilitating the delivery and receipt of data across networks (106, 108).

In various embodiments, a user device 104 may comprise software and/or hardware in communication with the system 100 via a network (e.g. network 106) comprising hardware and/or software configured to allow a user, and/or the like, access to the application server 102. The user device may comprise any suitable device that is configured to allow a user to communicate with a network and the system 100. The user device may include, for example, a personal computer, personal digital assistant, cellular phone, kiosk, and/or the like and may allow a user to transmit commands and requests to the system 100. In various embodiments, the user device 104 described herein may run a web application or native application to communicate with application server 102. A native application 110 may be installed on the user device 104 via download, physical media, or an app store, for example. The native application 110 may utilize the development code base provided for use with the operating system and capable of performing system calls to manipulate the stored and displayed data on the user device 104 and communicates with application server 102. A web application may be web browser compatible and written specifically to run on a web browser. The web application may thus be a browser-based application that operates in conjunction with application server 102.

In various embodiments, the native application 110 running on the user device 104 may be in communication with the application server 102 to support real-time updates. For example, data pertaining to the platform 200 may synchronize across the various user devices 104 used by any number of users interacting with the application server 102 and/or platform 200. In this regard, the application server 102 may serve data from platform 200 to each of the user devices 104 and may serve commands from the user devices 104 to the platform 200. In various embodiments, application server 102 may apply access permissions to restrict the data transmitted between the networks (106, 108) and/or the various components of system 100. Users may be authenticated on the native application 110, for example, via a username, password, dual factor authentication, private cryptographic key, one-time password, security question, biometrics, or other suitable authentication techniques know to those skilled in the art.

Most structures such as, for example, buildings and/or components therein, tend to have relatively long lifecycles. The progression of time tends to impact the internal systems of the building differently. With Mechanical, Electrical, and Plumbing (MEP), for example, short-cycle service elements like changing air filters or greasing bearings may be accomplished, but the long-term upgrades may tend to be un-planned or neglected. In this regard, there may tend to be a negative relationship between task cycle and task performance, i.e., short-cycle tasks are more likely to be performed whereas long-cycle tasks are less likely to be performed. Furthermore, factors which may influence allocation of a building maintenance budget tend to not be well understood or defined. In this regard, requirements definition for the structure and its associated long-term operations may be in conflict. For example, in a multi-family residence, leasing personnel may want a new lobby while operations personnel may want new air-conditioning units. The management requirement may be to fill vacant spaces. A management assumption may be that updated amenities will attract new tenants faster than having new A/C. However, where there is poor insight into building systems, this assumption may improperly discount the risk that the A/C units will fail, thereby reducing occupancy. As a result, management teams frequently gamble on the longevity of building equipment, thus tending to lead to an expensive, unplanned repair which may tend to exceed budget allocations. Insight may be lacking where the construction and maintenance history of the structure is unavailable or otherwise inaccessible. In this regard, the disconnect between the systems, processes, and the history for structure management tends to be costly and inefficient.

Several approaches may tend to reduce costs and improve efficiency in building management. Recommendations may be made based on observations and industry standard life cycle charts. Consultants may be called to evaluate buildings and make direct restoration work relative to service life projections for the system. Computer Maintenance Management Software (CMMS) may provide computer automated maintenance programs which direct the service activities based on equipment manufacturer maintenance schedule. CMMS systems may also comprise equipment sensors and learning models to predict system failures. However, each of these approaches fall short in that they tend to function in silos, fail to account for the overlap performance effect between systems in future actions, and do not calculate a Performance to Comfort (PC) Ratio.

In this regard, various shortcomings of these alternative approaches can be addressed by utilizing mobile device applications and/or related cloud-based systems configured in accordance with principles of the present disclosure. For example, the present system 100, in various embodiments, improves upon existing technology by capturing the performance history of the individual structure systems, measuring the performance result relative to the composite overlapping effect, and predictively directing maintenance activities for maximum return. The system 100 may calculate a PC Ratio for the building/property overall or the various systems/components therein. The PC Ratio categorically quantifies each system's characteristics in terms of operational significance (e.g., a performance rating) and aesthetic significance on a scale, for example, a 1-10 scale. For example, a roof's performance rating may have a value of nine because the roof performing its function (overhead shelter for the building and occupants) is very important for the building, as a whole, to perform its overall function (e.g., shelter). That is, if the roof fails, the building's overall performance significantly decreases. Similarly, the roof may have a relatively low aesthetic significance, i.e., an aesthetic significance of three. The aesthetic significance may be low, for example, because the building's tenants may not regularly interact with the roof. The system 100 may thus determine a PC ratio of three (i.e., 3:1) for the roof. In this regard, the system 100, in various embodiments, may trigger certain alerts or actions in response to weighing PC ratios between different systems or components in a building or complex, to determine priority for certain maintenance, repair, or replace action items. In this regard, where a large data set of structures is available, the system 100 may enable maintenance and capital improvements to be weighed against similar structures.

In various exemplary embodiments, the system 100 may provide a greater level of sophistication and/or control for facility management systems. For example, data may be gathered from multiple data sources and may be integrated for predictive purposes. In various embodiments, the current system 100 provides a technical solution by tending to enable integrated collection of quantitative data for analysis in conjunction with qualitative data. In this regard, the system 100 may enable accelerated operations, enhanced system life, improved tenant comfort, and reduced operational costs. As such, the system 100 may eliminate or reduce information gaps, reduce re-entry of data, and reduce record duplication, reduce record loss, and reduce development time. The system 100 may also reduce the cost of development or system processing time for data entry, reduce network utilization, and/or reduce data storage overhead. The system 100 may increase data reliability and/or accuracy by implementing distributed leger technologies and enabling comparison of data between structure portfolios at an increased frequency. The system 100 may also reduce redundant or duplicate maintenance tasks, thereby reducing a demand for maintenance resources. The system 100 may simplify data acquisition and enhance the user experience by decreasing the number of user interactions (e.g., for an order within the order flow, all options to assemble all supported order types are presented to quickly view full details and modify only the options necessary, therefore the user does not need to switch order types and reset previous selections). Moreover, benefits of the present disclosure may apply to any suitable system for predictive holistic facility management.

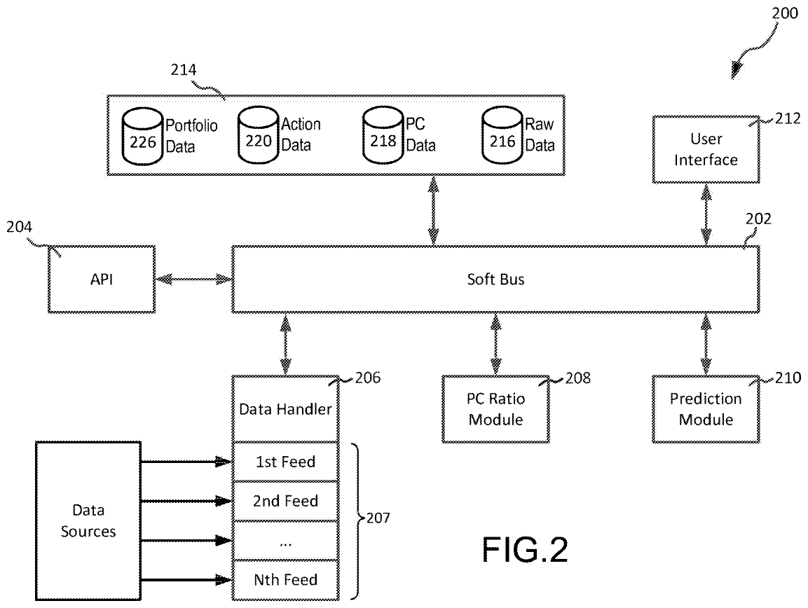

With additional reference to FIG. 2, a block diagram of a service 200 of system 100 is illustrated in accordance with various embodiments. Service 200 may comprise a software bus architecture 202, an application programming interface (i.e., API module 204), a data handler 206 module, a PC ratio module 208, a prediction module 210, a user interface module 212, and a database module 214.

In various embodiments, API module 204 may be configured to provide a programmatic interface to any of the set of system 100 or service 200 services, components, modules, and/or engines.

In various embodiments the data handler 206 is configured to capture and process data from one more data sources into a plurality of data feeds 207 for use by the various systems, engines, and components of service 200. In various embodiments, the data feeds 207 may be real-time data feeds. The data handler may be capable of integrating with a variety of data sources. In various embodiments, the data handler 206 may connect directly to a production database, thus providing the most up-to-date information for service 200 and thereby increasing predictive accuracy of the system 100. Data handler 206 may be configured retrieve data from active forms or from data files such as, for example, MICROSOFT® Excel files, comma-separated values files, and/or the like. In various embodiments, the data handler 206 may be configured to interface with one or more databases via customizable scripts for data retrieval. In various embodiments, the data handler may be configured to interface with one or more sensors, such as sensors of a smart building or piece of building equipment. The sensors may be configured to take measurements such as foot traffic, force, voltage, current, rotations, status, condition, rainfall, light, and/or the like.

In various embodiments, the user interface module 212 may provide outputs from the service 200 to the user devices 104, with further reference to FIG. 1. In various embodiments, the user interface module 212 may provide outputs through two channels such as, for example, a report file 226 or a dashboard.

In various embodiments, the database module 214 may include any number of data structures or data elements such as, for example, raw data 216, PC data 218, topic list 220 data, and report file 226 data. Database module 214 may be configured to maintain raw data 216 such as, for example, work orders, text files, sensor data, structure and/or building lists, and/or the like. Database module 214 may be configured to maintain PC data 218 such, for example, PC ratios for the various structures and their associated systems. Database module 214 may be configured to maintain action 220 data such as, for example, records of maintenance actions performed, data related to maintainers, and/or the like. Database module 214 may be configured to maintain portfolio 226 data such as, for example, records of related structures.

In various embodiments, the PC ratio module 208 may generate the PC ratios for the various structure systems based on data gathered by the data handler 206

In various embodiments, the prediction module 210 may perform time series and trend forecasting for maintenance actions and/or the like based on performance data and PC calculations of the PC ratio module 208 and data from the data handler 206.

In various embodiments, the system may perform a diagnosis or qualitative information gathering process. The diagnosis process may produce a Property Condition Report (PCA) which may serve as a baseline for the PC ratio calculation of the structure. In the diagnosis process, the property is evaluated with the individual property systems assessed, categorized, and logged into system 100. The data gathered by the system 100 includes historical documents (i.e., construction document plans, as-built reports, maintenance records, energy use records, and historical interviews of staff and tenants). The diagnosis process may include a triage review process where the building systems are ranked relative to the PC ratio and a combination of: life-safety (e.g., situation is dangerous such as bricks falling off the roof), viable-occupancy (e.g., space is unlivable such the roof leaks), compound-effect (e.g., lack of action will cause catastrophic failure such as not changing filters causing the A/C to fail), and tenant-draw (e.g., the building is undesirable to tenants, such as holes in the hallway carpets).

The system 100 may perform a correction phase process in response to the diagnosis process. In the correction phase, the system 100 may transition from qualitative to quantitative information gathering. The purpose of this process is to move properties and portfolio into a functional state based on the conditions observed during the diagnosis process. The correction phase process may include generation of a critical path plan. The critical path plan weighs the PC ratio for the property and systems therein against the PC ratio for the portfolio (e.g., including all properties) which is already logged in the system 100 to optimize resources (e.g., one structure may require some maintenance work, but another structure may require immediate emergency repairs). The system may generate a corrective plan based on the critical path plan. The corrective plan is established for each property with the actions logged into the system to direct what is done, when it is done, and who will perform the actions (e.g., engineering staff, third party consultants, or contactors with these groups having their contact information and ranking within the system). During the correction phase process, all actions taken are logged by the system for analysis against other metrics (e.g., energy usage, equipment replacements, occupancy changes, and lease charges).

The system 100 may perform a protection phase process in response to completing the correction phase process. The protection phase process may enable continual asset optimization across a portfolio of structures using predictive maintenance assessments based on the data processed by the system during the diagnosis process, the correction phase process, and continuing operation of the structure. Unlike the work in correction phase, which is directed by urgency identified in the critical path plan, the system 100 will direct the actions in the protection phase process based on analysis of cross-system metrics by the prediction module 210. All actions are projected (e.g., budgets and bids), scheduled (e.g., contracts and purchase orders), performed (e.g., scope of work and reports), and documented (e.g., digital contracts and digital measurements such equipment performance sensors and energy usage meters) by the system. In various embodiments the system may document weather events (e.g., deep freeze, storms, hail, and floods) for predictive analysis by the prediction module 210. In this regard, the system may enhance returns by extending analysis of systems beyond the projected life cycle, directing resources toward productive activities, improving energy efficiency, balancing the PC ratio to increase occupancy at higher lease levels, and managing the portfolio holistically. In various embodiments, records may be preserved in the database module 214 and events may be validated by implementing distributed ledger technologies such as blockchain protocols allowing simultaneous access, validation, and record updating in an immutable manner across the system 100's users. As an example, data regarding the previous maintenance and performance of a building and its components may be input into a blockchain (e.g., a block chain in electronic communication with, or incorporated into, system 100). Such association and utilization of a blockchain will allow verifiable historic data about buildings and components therein. Thus, present and future owners of the respective buildings or assets may be able to continually access accurate data about their properties, and continually implement and develop management and maintenance processes based thereon and in accordance with the embodiments of this disclosure.

For example, in the instance where the structure is a commercial office building and there are two tenants each occupying a respective suite, the system may enable a predictive maintenance schedule for air filtration. Suite 1 tenant, for example, may make prototype equipment as a third-party R&D firm. In the process of creating prototypes, they will generate a moderate level of dust on a weekly basis. In about 1.5 months, the air filter in their HVAC unit will be clogged enough to require replacement. Suite 2 tenant is a software service provider, and the staff will not occupy the suite 50% of the time. Due to the low level of actual activity their filters will require replacement every 9 months. However, these conditions are not known to the building management or engineering team.

A traditional assumptive maintenance schedule would comprise the HVAC manufacture recommendations that the filters be replaced every 3 to 6 months. The building engineering team is proactive by replacing all the filter every quarter (i.e., every four months), scheduled on paper or through a CMMS program. This would tend to result in suboptimal filter performance for suite 1 and wasted labor and parts for suite 2.

Applying the processes of the system described above, the diagnose phase process captures the current state of the equipment from visual observations, reviewing the historical energy data, and logging the data into the system. The correction phase process begins by replacing the filters directed by the system based on the observations in the diagnosis phase while continuing to capture the current state of the equipment from visual observations, reviewing the historical energy use, calculations of the building envelope performance, historical weather conditions, and logging the data into the system. Based on the collected data, the system may determine a filter replacement schedule of one month for suite 1 and nine months for suite 2. The system may enable verification of maintenance activities by the engineering team via logging of activities. In this way, the system 100 may tend to extend life of HVAC components producing increased value of the unit, decreased energy uses lowering operation cost, and improved air quality for the tenant of suite 1. Similarly, the system 100 may enable reduction of labor, increase opportunity value from engineer availability, reduce material expense from unused filters, and energy saving from software directed zonal shutdown of systems in suite 2.

In another example, for a multi-story mixed use office building, the system may enable predictive cleaning and scheduled renovation based on traffic patterns. An important aspect for maximizing occupancy and revenue is the appearance of the property and the elevator hallways (e.g., common areas). For example, the existing flooring is 7 years old and the real estate brokers are requesting that the hallways be updated because the flooring is looking worn. Engineering's first action is to schedule an additional floor clean with little result. The property manager then schedules a third-party cleaning company with good initial results, but the appearance fades within months. Finally, ownership contracts for a hallway renovation prompted by the flooring replace, but the project is not part of the original maintenance budget.

A traditional assumptive maintenance schedule would comprise flooring manufacture recommendations for the floor covering to be vacuumed daily, cleaned on a regular interval, and to be replaced every 10 years. The build engineering team is proactive with the cleaning crew vacuuming nightly and an annual cleaning scheduled on paper or through a CMMS program. Process results on floors 2 and 4 is that the flooring is in good condition and will have at least 3 more years of service life before needing replacement because the foot traffic for these floors is at a traditional level for office workspaces. Process results on floors 3 and 5 is that the flooring is in poor condition and needs replacement because the 3rd floor is doctor office with high foot traffic, and the 5th floor is a temporary work agency with very high foot traffic. Process results for the whole building is that viable flooring is unnecessarily replaced on floors 2 and 4, while inadequate flooring material is used on floors 3 and 5 which will cause the same cycle to repeat in 7 years. In various embodiments, the system 100 may comprise foot traffic sensors which may generate foot traffic data for processing and interpretation. In various embodiments, the system 100 may calculate and predict a remaining service life for floor coverings based on the foot traffic data.

Applying the processes of the system described above, the diagnose phase process captures the current state of the flooring from visual observations, assessing tenant activities, reviewing the historical traffic, and logging the data into the system. The correction phase process begins evaluating the hallway floor covering relative to cleaning cycles and wear patterns directed by the software based on the observations in the diagnose phase while continuing to capture the current state of the flooring from visual observations, reviewing the historical lifecycle of flooring, and logging the data into the system. Based on the collected data, the protection phase implements the determinations of the prediction module 210 (which may be enhanced by processing data from the security sensors of the halls) of the captured data, the timing for increased cleaning of flooring in high traffic areas, recommending different flooring materials, and sequencing motif changes on alternating floors. In this regard, the system 100 may enhance tenant experience, the life cycle of the flooring is increased due to proper cleaning cycle relative to traffic, and the use of appropriate floor material relative to traffic directs the more costly high-performance product for the right application.

In another example, for an old multi-suite office building, the system 100 may enable predictively replacing elevation weathering to reduce energy loss and enhance tenant comfort. The building is 13 years old and located in Houston, Tex. Multiple tenants from the south elevation and two from the west elevation complain about wallpaper pealing around windows, but no leaks are visible. Additionally, energy consumption has increased in both the summer and winter for three years. The engineering staff removes the wallpaper from around the windows in the affected suites and finds moisture stains with black spots. The staff treats the areas with a stain and mold blocking primer then installs new wallpaper.

A traditional assumptive maintenance schedule would comprise sealant manufacturer's projected service life for the sealant used to seal the exterior window termination is 15 years. The build engineering team that opened the building was promoted to new buildings and the current staff is unaware of the building's age. There is no proactive plan to review the exterior sealants and the CMMS program is directed at internal equipment. There is a capital plan to review the building exterior at the 15-year mark with all sealants scheduled for replacement. Process results in most suites from the south elevation and large percentage of suites from the west elevation experience varying levels of water intrusion around the windows where the sealant is failing. The water intrusion causes mold growth in the walls and rusting of the steel wall studs in all the affected suites. The situation will worsen for the next two years as the sealants are exposed to harsh solar exposure in the south and west. Process results in energy wasted from the building envelope for multiple years, deteriorated structure, and sick building syndrome from the mold.

Applying the processes of the system described above, the diagnose phase process captures the current state of the building envelope components from visual observations, reviewing the historical energy use, and logging the data into the system 100. The correction phase process begins replacing the sealant in a sequenced process starting with south and west elevations while monitoring the east and north. Perform interior evaluations to determine the level of required mold remediation. The system directs the actions based on the observations in the diagnose phase, simultaneously capturing the state of envelope components, analyzing the energy consumption, and logging the data into the system. The prediction module 210 may calculate a replacement schedule based on the collected data including, for example, data from moisture sensors, building energy usage, climate control systems, and/or the like. In this regard, they system may tend to enable decreased energy consumption, lower operational costs, reduce or eliminate mold remediation costs, and tend to improve interior air quality.

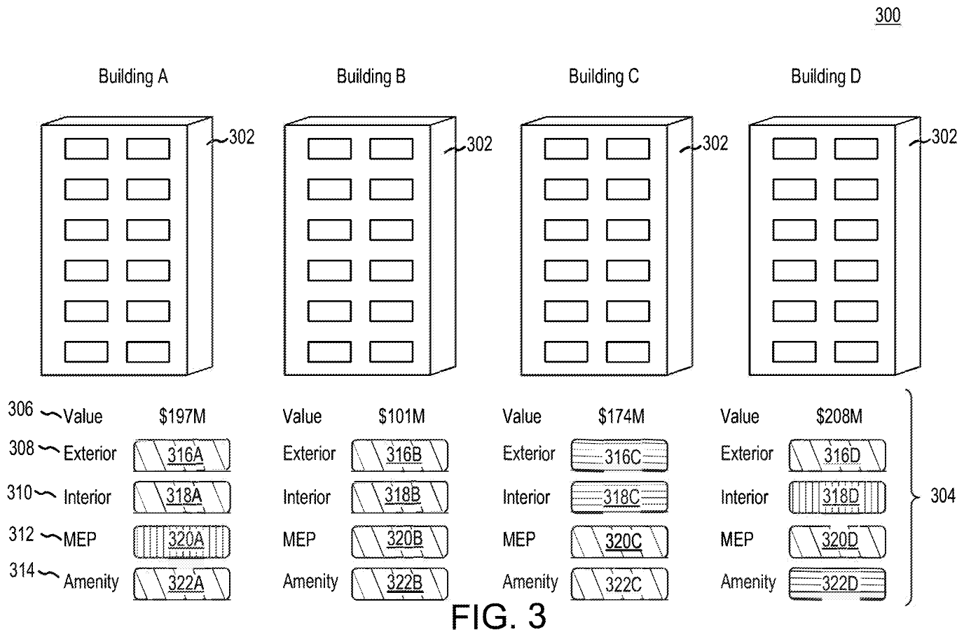

In various embodiments and with additional reference to FIG. 3, application server 102 may display a graphical user interface (GUI) on a user device 104 to present information to the user. For example, such a GUI may comprise a property portfolio page 300 of system 100 is illustrated. Page 300 displays one or more properties (i.e., Building A, Building, B, Building C, . . . Building n) captured in system 100. Page 300 may display an image 302 associated on a one-to-one basis with each of the properties thereby enabling expedient visual reference of the property. Page 300 includes a property status frame 304 which displays a status associated with primary elements of the associated property. In various embodiments, the property status frame 304 includes status for primary elements such as value 306, exterior 308, interior 310, Mechanical Electrical & Plumbing (MEP) 312, and amenity 314. Value 306 may be displayed in dollars. In various embodiments, each of exterior 308, interior 310, MEP 312, and amenity 314 may have a status indicator associated with the property. For example, Building A may have indicators 316A, 318A, 320A, and 322A associated with the primary elements 308, 310, 312, and 314. In like regard, building B, C, D . . . n may have similarly associated status indicators.

In various embodiments, each of the status indicators may display an indicator indicating whether a property or aspect thereof is at low or no assessed risk, moderate assessed risk, or high assess risk. For example, each of the status indicators may display one of a ‘green’ (to indicate low or no assessed risk), a ‘yellow’ (to indicate moderate assessed risk) or a ‘red’ (to indicate high assessed risk) status, shown in FIG. 3 as different patterns of cross hatching. For example, status indicators 320A and 318D may display a ‘red’ status; status indicators 316C, 318C, and 322D may display a ‘yellow’ status; and the remaining indicators may display a ‘green’ status. The system may determine the displayed status based on one or more secondary elements and/or subsystem elements associated with the corresponding primary element. In this regard, the status indicator may ‘roll up’ the status of the lower tiered elements. For example, where a secondary element or subsystem element, such a lower tiered element of the MEP of Building A, has a red status, the system may set status indicator 320A to red. In another example, where a secondary element or subsystem element, such as a lowered tiered element of the exterior of Building C and/or a lowered tiered element of the interior of Building C, has a yellow status, the system may set status indicators 316C and 318C to yellow. In various embodiments, the green status may be set by the system where no issues are detected in the associated element. In various embodiments, the yellow status may be set by the system where a time-based action is required by the system user such as, for example, a preventative maintenance action, an inspection, a scheduled replacement, and/or the like. In various embodiments, the red status may be set by the system where sensor data indicates failure of an element, a time-based action is not performed within the established time window, where an immediate action of the system user is required, wherein a safety risk is detected, and/or the like.

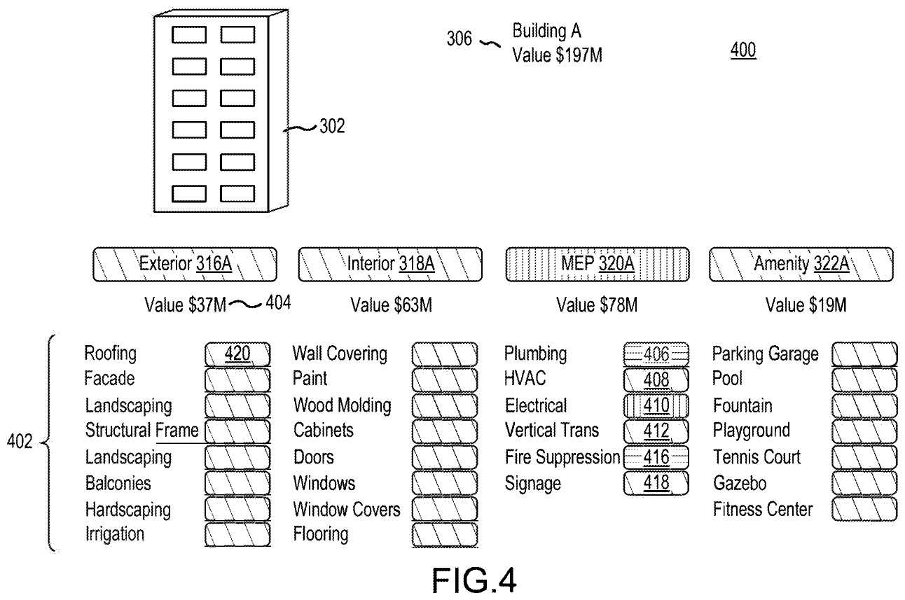

In various embodiments, and with additional reference to FIG. 4, a property management dashboard 400 of system 100 for Building A is illustrated. Dashboard 400 may be displayed in response to Building A in response to a user of the system selecting Building A on property portfolio page 300. Dashboard 400 includes one or more secondary elements 402 associated with the primary elements 308, 318, 312, and 314. For example, the exterior 308 primary element may be associated with secondary elements such as roofing, façade, landscaping, structural frame, balconies, hardscaping, and irrigation. In another example, the interior 310 primary element may be associated with secondary elements such as wall covering, paint, wood molding, cabinets, doors, windows, window covers, and flooring. In another example, the MEP 312 primary element may be associated with secondary elements such as plumbing, Heating Ventilating and Air Condition (HVAC), electrical, vertical transport, fire suppression, and signage. In another example, the amenity 314 primary element may be associated with secondary elements such as parking garage, pool, fountain, playground, tennis court, gazebo, and fitness center. It will be appreciated that secondary elements may be initially configured, added, and removed by the system based on the as-built configuration of the associated building and changes in the as-built configuration over time.

In various embodiments, each primary element may have an associated value 404 displayed on the dashboard 400. The value 404 may be calculated of the estimated value of each of the secondary elements of the associated primary element. Each of the secondary elements may have a corresponding status indicator associated with the secondary element. For example, plumbing, HVAC, electrical, vertical transport, fire suppression, and signage may have status indicators 406, 408, 410, 412, 416, and 418 respectively. In various embodiments, each of the status indicators may display one of the green, yellow, or red status, similar to the discussion above. For example, status indicators 406 and 416 may display the yellow status while status indicator 410 displays the red status with the remaining indicators displaying the green status. As discussed above with regard to FIG. 3, the system may determine the displayed status based on one or more subsystem elements associated with the corresponding secondary element. In this regard, the status indicator may ‘roll up’ the status of the lower tiered elements. As shown, indicator 410 is red and the red status has rolled up to indicator 320A.

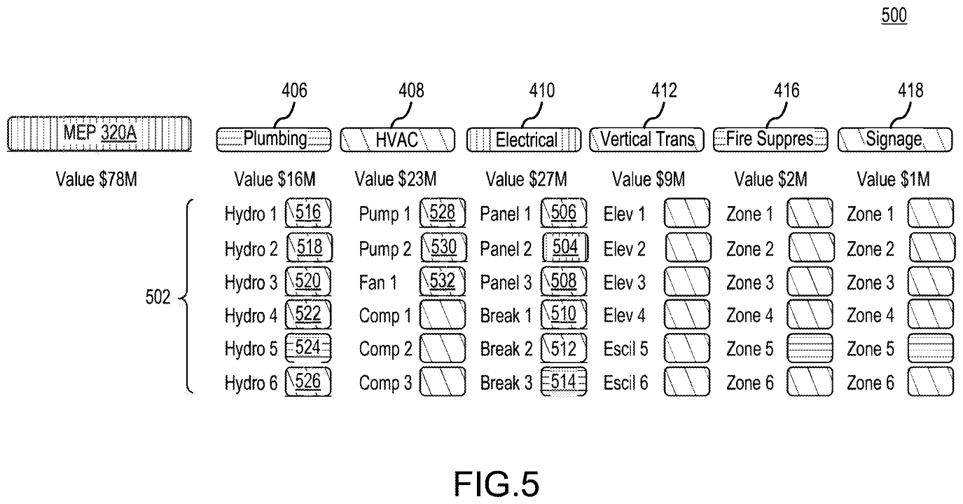

In various embodiments and with additional reference to FIG. 5, a subsystem status page 500 of system 100 is illustrated for the MEP element of Building A. Subsystem status page 500 may be displayed in response to a user of the system selecting the MEP element for Building A on dashboard 400. Page 500 shows a plurality of subsystems 502 and their corresponding status indicators each associated with their respective secondary elements of plumbing, HVAC, electrical, vertical transport, fire suppression, and signage. Subsystems 502 may, for example, be representative of collections of components and equipment delivering particular functionality to a part of the structure (e.g., Fire suppression zone 1 comprises all fire suppression equipment on the first floor of Building A), or may represent individual system components (e.g., pump 1, pump 2, and fan 1 of the Building A HVAC system). As discussed above, each of the status indicators may display one of the green, yellow, or red status and the indicator status may roll up to the next level. For example, status indicator 504 for panel 2 of the secondary element ‘electrical’ may be set to red by the system with indicator 514 set to yellow and remaining indicators 506, 508, 510, and 512 set green. In this instance, the red status of indicator 504 may roll up and set indicator 410 to red. In another example, indicator 524 for hydro 5 of the plumbing secondary element may be set by the system to yellow with the remaining indicators 516, 518, 520, 522, and 526 set green. The yellow status of indicator 524 may roll up and set indicator 406 to yellow. In various embodiments, a status indicating a higher risk than other status indicators may have priority in being rolled up to a higher-level page or interface to indicate the status of the overarching element. For example, if there are two yellow indicators, one red indicator, and the rest green indicators relating to an overarching element, the higher-level page or interface may display a red indicator, which indicates that there is at least one sub-element that is high-risk.

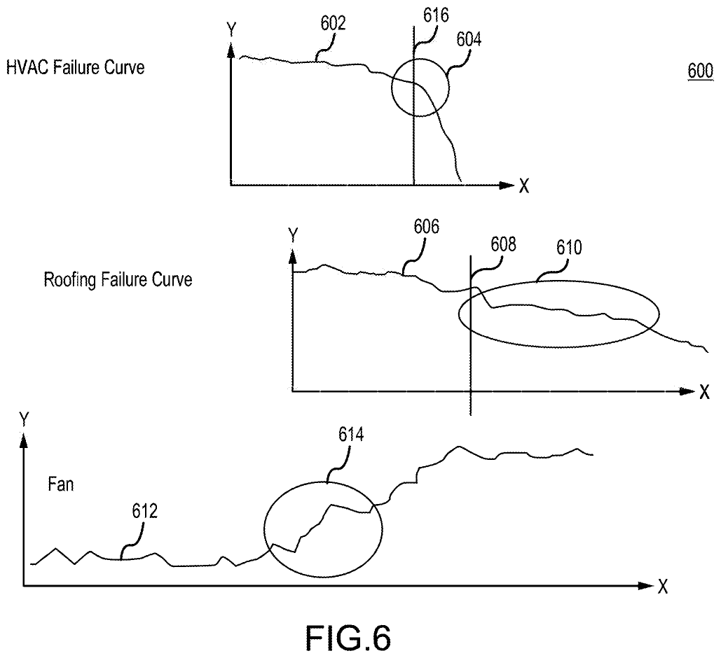

In various embodiments and with additional reference to FIG. 6, a series of failure plots 600 are illustrated. In various embodiments, system 100 may set the high, intermediate, or low risk status indicators based on selected failure curves associated with the various primary elements, secondary elements, and subsystems. For example, the system may determine the risk level of a certain element based on data or data trends in the relevant system or subsystem. For example, the ‘HVAC Failure Curve’ may be detected and plotted with reference to time on the X-axis and reliability on the Y-axis. The HVAC Failure curve may be associated with HVAC subsystems and thereby may be associated with indicators 528 and 530 for pump 1 and pump 2. Progressing in time along the curve through region 602 the system may set indicators 528 and 530 to green. As time progresses to region 604 (denoted by the circle) where reliability is likely to drop quickly with respect to time, the system may set the indicator 528 and 530 to yellow. As time progresses past point 616 (vertical line proximate the knee), where reliability sharply begins to drop the system may set the indicators 528 and 530 to red.

In another example, the ‘Roofing Failure Curve’ may be plotted with reference to time on the X-axis and reliability (e.g., a resistance to leaking) on the Y-axis. The roofing failure curve may be associated with the roofing secondary element (recall FIG. 4) and indicator 420. Progressing in time along the curve through region 606, the system may set indicator 420 to green. As time progresses past point 608 (vertical line) the system may set the indicator 420 to yellow indicating a reduced resistance to leaking. As time progresses beyond region 610, the system may set indicator 420 to red indicating that the roofing resistance to leaking has reached a critically low level. In various embodiments, the failure curves may be parametric equations governed by one or more system inputs received in the diagnose phase process. The system may apply machine learning models to modify the equations over time based on operational data received from the various sensors and based on user inputs from periodic maintenance operations.

In various embodiments, at a decision juncture in which some repair or maintenance should take place, but at which resources are limited, a user may be required to choose between suggested or needed repair or maintenance actions. The failure curves can be helpful in making such decisions. The system can present the failure curves to show which system might be able to maintain utility even past the point of utility decline (point 616 in HVAC Failure Curve, and point 608 in Roofing Failure Curve). Thus, a determination can be made (e.g., by the system) with regard to which system should be repaired/maintained. For example, because the utility of the HVAC system will experience swift decline after point 616, while the roof utility will decline slowly after point 608 (i.e., still maintain some or sufficient utility even after point 608), a determination may be made that the HVAC system should receive attention first. That is, if the HVAC system wears exponentially and quickly fails, the building becomes unusable and/or unlivable, while if the roof gradually wears, the building can maintain function during such gradual wear.

As discussed above, the system may receive sensor data from various sensors associated with secondary elements, subsystems, and components. For example, the system may receive data from a current sensor associated with Fan 1 of the Building A MEP HVAC secondary element. The sensor data may be plotted as illustrated the ‘Fan’ curve with time on the X-axis and average current draw on the Y-axis. In region 612 where current draw is nominal, the system may set indicator 532 associated with fan 1 to green. The system may monitor the sensor data, and in response to detecting an anomalous rise in current draw as shown in area 614, the system may set the indicator 532 to red. In this regard, the system may alert the user of the anomalous condition in the fan thereby increase the efficiency and expediency of maintenance operations.

In various embodiments, the system may generate automated maintenance reminders based on setting an indicator status to a high or intermediate risk level. In various embodiments, the determination of intermediate risk level status may be affected by a collateral damage cost input. For example, where a high collateral damage cost is associated with a secondary element or a subsystem element, the system may expand a region of the associated failure curve (e.g., region 610) and thereby the frequency of maintained and/or inspection alerts may be increased. In this regard, the system may assist a user in prioritizing maintenance operations for a building such as Building A in a cost-effective manner.

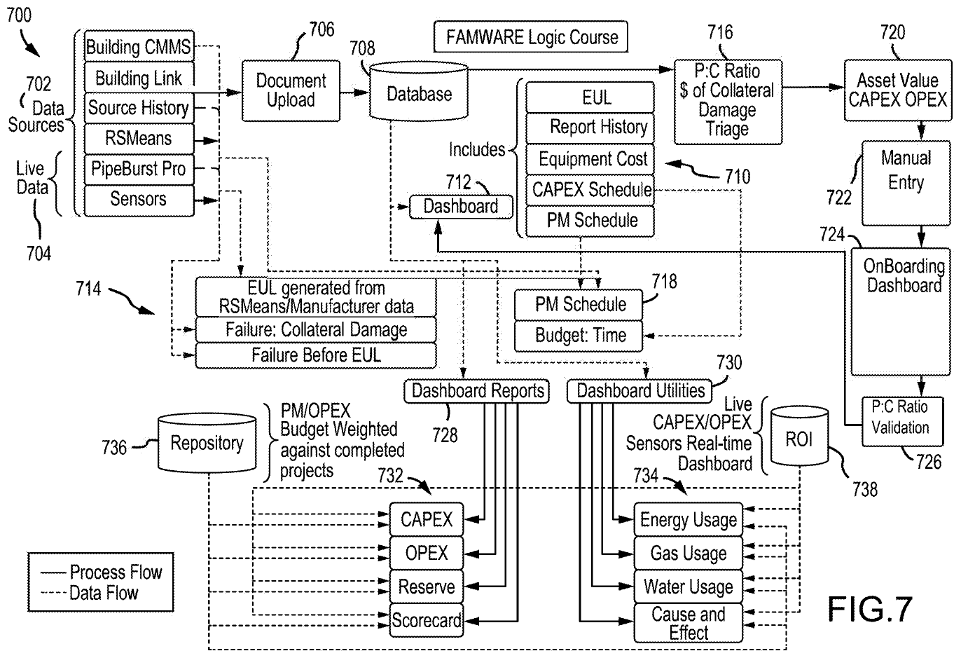

With reference to FIG. 7, system 700 is illustrated in accordance with various embodiments. System 700 is similar to system 100 described above. System 700 comprises data sources 702. Data sources 702 comprises building CMMS, building link, source history, RSMeans (construction cost estimating software), PipeBurst Pro (electromechanical water shut off valves and other water control systems), and various other sensors. Data sources 702 comprises data related to the construction and prior maintenance history of the building. Data sources 702 represent the data incoming into the system 700 that input information about the building and or property at issue, the features of the property, the steps that have been taken to preserve and maintain the property, and other data related to the usage of the property. In that regard, data sources 702 may comprise physical sensors such as cameras, infrared cameras, motion detectors, other optical imaging devices, pressure measuring devices, thermostats, thermometers, barometers, wind vanes, predicted and actual weather, and other devices that measure the physical aspects of the building, its occupants, and/or ambient environment. Data sources 702 may further comprise information and documentation related to building maintenance activities history, damage, occupant complaints, maintenance requests, and other sources of information that relate to the building, its occupants, and ambient conditions.

Live data 704 comprises a subset of data sources 702 comprising PipeBurst Pro and various other sensors. Live data is 704 comprises data from one or more sources in real time that reports actual conditions at a building or property. Live data 704 may be direct observations such as images, video or audio recordings, or may be the product of analysis of the same. For example, live data 704 may comprise a processed series of video that estimates the number of occupants that have passed through a given space in a given period of time or has been processed through facial recognition software to identify one or more occupants, with the identity of those occupants linked to one or more personal profiles that contain information related to a person's role at the building and the person's likely activities that may result in increased or decrease wear on the building or its systems. Live data 704 may comprise third party sensor services. Third parties may provide various sensors located at a building or property that collect data. That data may be sent to a third party hosted service, such as a cloud service. For example, third-party thermostats, video surveillance systems, home assistants, and various other devices may be used to collect data relating to the building or property that is analyzed by the third party and stored for example, in a cloud system.

As illustrated, data sources 702 may include a variety of sources, as described below.

Building CMMS is standard software used by most facility management companies and their maintenance teams. The Building CMMS provides a solid source for historical data with ongoing active management of work orders and inventory. By utilizing the existing system, adoption time and training is reduced.

Building Occupant Work Order System (Building Link) is a standard occupant interface that allows communication between the occupants and the maintenance staff. The system provides a visible history and time of requests and responses with time stamps. Beyond improving occupant experience, the historical data can be used to identify building function trends. By utilizing the existing system, adoption time and training is reduced.

Source History is derived from construction data such as specification, architectural drawings, as built drawings, warranty documents, insurance claims, and major weather events. Additionally, Source History includes information from interviews, invoices, and reports.

Cost Indexes, such as RSMeans, are industry accepted costing tables showing data such as yearly maintenance, scheduled repair, and eventual replacement cost. These tables provide a baseline to access or validate current or future activity expenditures.

Third Party Sensor Services, such as PipeBurst Pro, provide live data for activities and/or failures of components or systems within the building. The live feed provides the ability to quickly respond to issues with onsite support and notify outside support.

Sensors provide live data of the performance for various building system components. The data provided by the sensors can be constantly analyzed to detect and predict maintenance schedules or replacement before the events occur, minimizing collateral damage to other systems and continually optimizing performance and ROI (return on investment).

Data sources 702 feed into document upload 706. Document upload 706 may be one or more middleware modules that process the information from data sources 702 and aggregate, sort or otherwise transform the input data for suitable storage into database 708. Document upload 706 may be facilitated by an API or it may be facilitated by a graphical user interface (GUI) for use by a data entry personnel. Data sources 702 may input data in a structured format, such as an XML stream or delimited file (e.g., CSV file) to document upload 706. Document upload 706 may take the input XML stream or delimited file and transform or otherwise map the input data into database 708.

Database 708 a collection point for data collected by system 700. Database 708 may be sorted or organized into separate data types by building portion (Interior, Exterior, Amenities, and MEP), and separate it further into sub-equipment groups (i.e., HVAC, Plumbing, and Fire Suppression) as well as property location. Various algorithms and/or artificial intelligence processes may sift through the provided data to organize the data into the data sets. These data sets will then be given values for price, estimated useful life, and installation date. This will create “whole” data sets that is then sent to further processing for PC Ratio, and collateral damage, as well the percentage of time remaining until the asset needs to be replaced.

PC Ratio calculation 716 takes data from database 708 and performs various calculations to determine a PC Ratio for a building or property based on the input data. The data from database 708 may be weighted or discounted in PC Ratio calculation 716 depending on a variety of predetermined factors, as described herein.

PC Ratio weighs the difference between the true costs of a system's failure in the building where it functions. Performance ratings are derived from the replacement cost (today's value or projected value) plus the collateral damage created throughout the building due to its failure. Comfort ratings are derived from the value of revenue generating square footage affected by a system's failure in the building where it functions. PC Ratio acts as an informational terrain to guide a building onto the path of correction and protection. PC Ratio is designed as a starting on that path.

The PC ratio from PC ratio calculation 716 may be input into asset value calculation 720. Asset value calculation 720 may take the PC ratio as calculated for one or more buildings or properties together to determine an asset ratio. Asset value calculation 720 may further comprise determining an appropriate level of capital expenditure and operational expenditure to dedicate to the one or more buildings based upon the PC ratio calculated in PC ratio calculation 716. For example, where there is a high PC Ratio further operational expenditures may be warranted. Where there is a low PC Ratio, additional capital expenditures may be warranted.

Asset value calculation 720 may comprise determining, by the summation of all the building's equipment depreciated over time to calculate today's value.

CAPEX refinement is continuous throughout the correction and protection phases. As equipment or systems cycle past their EUL (Estimated Useful Life) (either due to age or as a net gain), scheduled replacement will commence. The schedule will have budget amounts for each item per year. CAPEX budget may span 10 years or more while maintaining accuracy each year. With the addition of Cost Index API's and machine learning, system 700 can automatically generate CAPEX information in response to property data being entered into database 700.

To supplement estimated costs, manual entry 722 may be used to add additional estimated costs, if needed.

Onboarding dashboard 724 populate dashboard 712. Dashboard 712 comprises one or more interfaces that display various information related to the building. Dashboard 712 may present this information an easily repeatable manner. Dashboard 712 is the visual interpretation of the building's data. Dashboard 712 displays the data which may be grouped together by identifiers for ease of access and viewing. The dashboard 712 may display color coded logic to show the status of the building

Color coding may be accomplished as red, yellow and green. Criteria for red include:

Less than 10% EUL

### Failure: Collateral High Risk

Failed before EUL
PM not done

### Life/Safety Issue

Over budget/over time
P:C Ratio under a first predetermined threshold

Criteria for yellow include:

Less than 20% EUL

### Failure: Collateral Medium Risk

Failed before EUL
PM out of cycle

### No Life/Safety Issue

Over budget or time

P:C Ratio under a second predetermined threshold

Criteria for green include:

Greater than 20% EUL

### Failure: Collateral Medium Low

Failed before EUL

### Within PM Cycle

### No Life/Safety Issues

On budget & time
P:C Ratio exceeding the second predetermined threshold.

Dashboard 712 may be displayed on a graphical display device such as a CRT monitor, LCD screen, OLED screen or the like. Dashboard 712 may be displayed on a display device attached to or otherwise coupled with a cellular phone, tablet device, laptop computer, desktop computer, in vehicle display, or other mobile device capable of communication with system 700.

PC Ratio Validation 726 may comprise a secondary reconciliation process wherein the PC ratio calculations may be examined and reconciled with the input data from database 708. PC ratio validation 726 may be performed automatically via various algorithms and or machine learning software.

Dashboard utilities 730 comprises a graphical interface related to various data of a building's usage of utilities. A building's usage of utilities may be stored in ROI 738. ROI 738 may comprise various utility usage 734 comprising, for example electrical energy usage, natural gas usage, water usage, other utility usage such as Internet data. Dashboard utilities 730 aggregates and organizes data from ROI 738 to graphically display the consumption of utilities a particular building. The dashboard utilities 730 usage (Gas, Water, and Electric) will allow the client to see the footprint of each asset, and will also serve as a warning system for system 700 (if a pump suddenly begins to use more water than normal, something has changed)

Dashboard report 728 comprises a graphical interface related to various data of a building's budgetary plans and forecasts. Repository 736 comprises data related to a buildings PM ratio, operating expenditures, budget that may be weighted against ongoing projects at the building. Repository 736 further comprises information related to a building's budgetary data 732, which comprises, for example capital expenditures operational expenditures reserve funds. Dashboard report 728 may graphically display this information or output this information in an XML file or display on a display device.

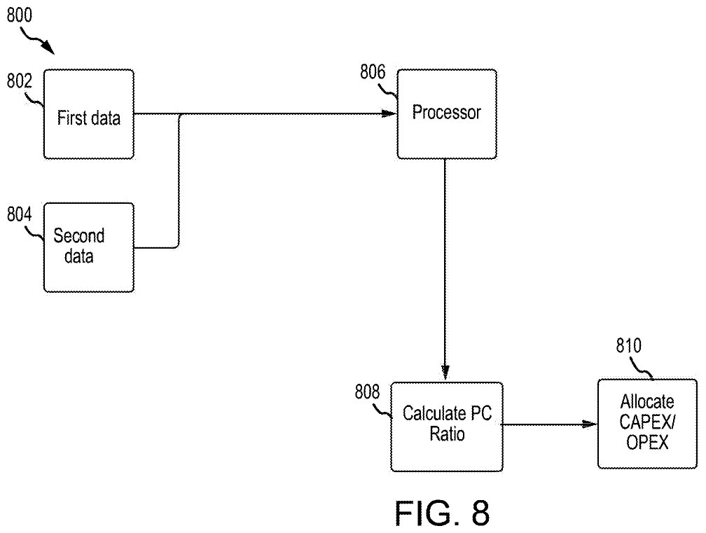

With reference to FIG. 8, method 800 is illustrated. First data 802 comprises data received from a sensor, for example, live data 704, with momentary reference to FIG. 7. However, live data 704 that is captured and stored, for example, in a cloud service, may also comprise first data. Second data 804 comprises data related to the history of a building, its construction, and its presently current associated systems. Processor 806 takes first data 802 and second data 804 and calculates, using the methods disclosed herein, the PC Ratio. Processor 806 then takes the PC Ratio and allocates CAPEX and OPEX, consistent with the methods disclosed herein. Method 800 may also be supplemented by any of the methods also disclosed herein.

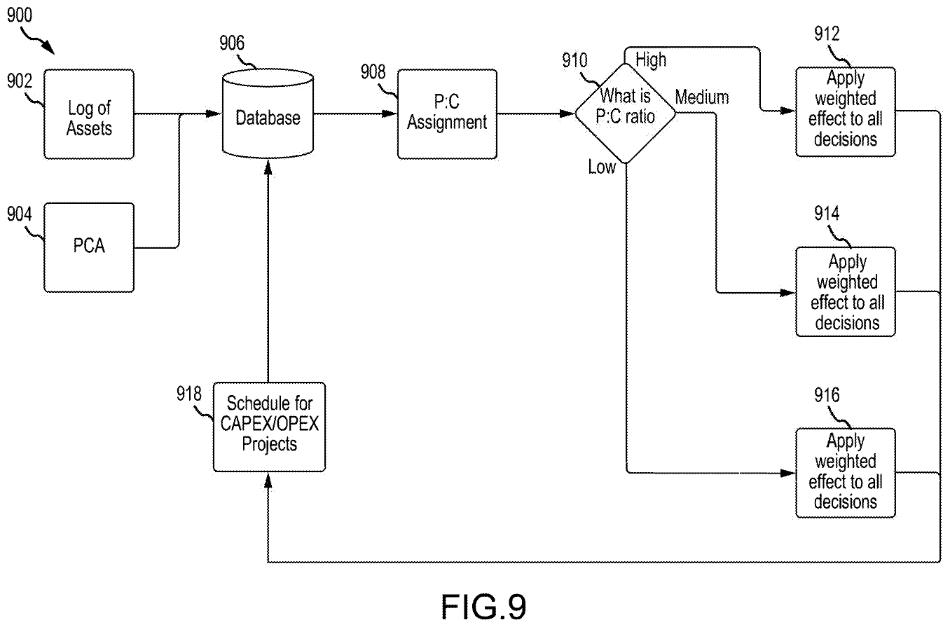

With reference to FIG. 9, method 900 is illustrated. At log of assets 902, a portfolio of buildings and/or properties is loaded into database 906. At PC Ratio assignment 908, the PC Ratio is determined for each building and/or property in database 906. The methodology for determining PC Ratio is as described herein above. For each building and/or property where PC Ratio is assigned in PC Ratio assignment 908, a decision point 910 is executed. At decision 910, the PC Ratio is sorted into a category of at least one of high, medium, and low, in accordance with predetermined threshold for categorizing PC Ratio. In response to a high PC Ratio, apply weighted effect to all decisions 912 occurs. In response to a medium PC Ratio, apply weighted effect to all decisions 914 occurs. In response to a low PC Ratio, apply weighted effects to all decisions 916 occurs. In apply weighted effect to all decisions 912, 914, and 916, different weights of values are applied to the PC Ratios in accordance with the PC Ratio status of being at least one of high medium or low. The output from apply weighted effect to all decisions in 912, 914, 916 is to schedule capital expenditures and/or operating expenditure projects 918 in accordance with budgetary predetermined inputs. At schedule capital expenditures and/or operating expenditure projects 918, the predetermined budget for capital expenditures and operating expenditures is allocated to each of the properties and/or buildings in database 906 so as to maximize or tending to maximize the PC Ratio of the entire portfolio in the aggregate. In that regard, it is not only the high PC Ratio properties that receive funding but the predetermined funding threshold budget is applied across the buildings and/or properties to tend to raise the overall aggregate PC Ratio of the portfolio. This is important for investment purposes so that the entire portfolio tends to raise in PC Ratio as opposed to having certain buildings and/or properties receive funding to improve their value, while other buildings are left at risk of collateral damage or system failures. Moreover, this methodology allows for capital expenditures and operating expenditures to be efficiently allocated. As described above, PC Ratio allows for allocation of resources in a manner that tends to minimize waste based on actual wear experienced. In that regard, resources are allocated to the systems that need attention and not based solely on time parameters, which fail to take into account the effects of use or nonuse. The allocation of capital expenditures and operating expenditures may be conducted automatically. In that regard purchase orders may be automatically generated and transmitted the various messaging protocols to various vendors to procure the relevant goods and services to apply to the buildings and or properties.

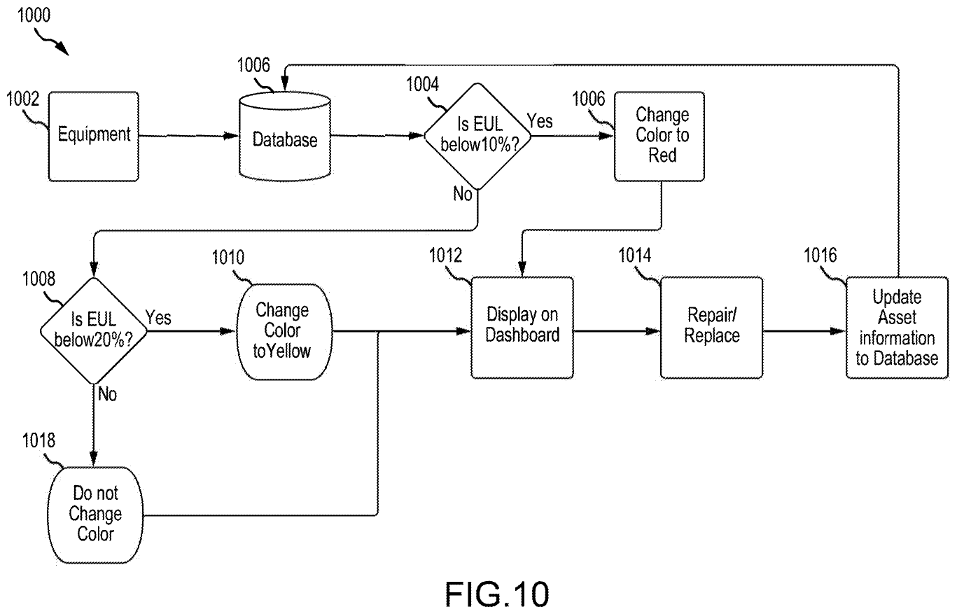

With reference to FIG. 10, method 1000 is illustrated. Equipment 1002 comprises an inventory of equipment and replaceable items in a building and/or property. For example, equipment 1002 may comprise air filters, thermostats, light bulbs, fuses, carpeting, plumbing fixtures, HVAC systems, finished carpentry, valves and other rough plumbing items, and other equipment that is affixed to or otherwise associated with the building and/or property. Equipment 1002 is loaded into database 1006, along with other information about the equipment from the equipment manufacturer and/or installers of the equipment. From database 1006, the EUL is determined at EUL 1004. In EUL 1004, the EUL is determined to be above or below 10%. In response to EUL being below 10%, change color to red 1006 occurs. At change color to red 1006, a display device may be changed to a color red to indicate that a particular piece of equipment is below EUL 10%. In response to an EUL being above 10% it may be determined at EUL 1008 whether the EUL of the particular piece of equipment is below 20%. In response to EUL being below 20%, change color to yellow 1010 occurs. Change color to yellow 1010 comprises changing the color of a display device to yellow to indicate that the EUL of the particular piece of equipment is below 20%. In response to EUL being above 20% do not change color 1018 is executed. At display on dashboard 1012, the status of the EUL for each piece of equipment is displayed on the display device. The display on the display device may be green, yellow, or red in accordance with the method as described here in. The display on dashboard 1012 may indicate that repair or replacement is needed for certain pieces of equipment. At repair/replace 1014, equipment that is at least one of below 20% EUL and/or below 10% UL is scheduled for repair and/or replacement. The scheduling of repair or replacement may be done automatically. For example, a purchase order may be generated automatically by the system and transmitted to a predetermined repair personnel or repair vendor for repair for the particular piece of equipment or replacement of a particular piece of equipment. At update asset information 1016, database 1006 is updated to reflect the status of the EUL of the particular equipment and updated to reflect whether the repair or replacement has been completed. At update asset information 1016, the updating may be done automatically in response to input from a vendor system. For example, a vendor may send an invoice to reflect replacement of a particular piece of equipment. That invoice may be parsed and or otherwise processed and fed into database 1006. They invoice from the vendor may include items such as the particular piece of equipment replaced, the serial number of the new piece of equipment, the other particulars of the installation of the piece of equipment, warranty information from the manufacturer for that piece of equipment information regarding the vendor such as name and phone number and contact information, as well as the name and contact phone number and e-mail address for the manufacturer.

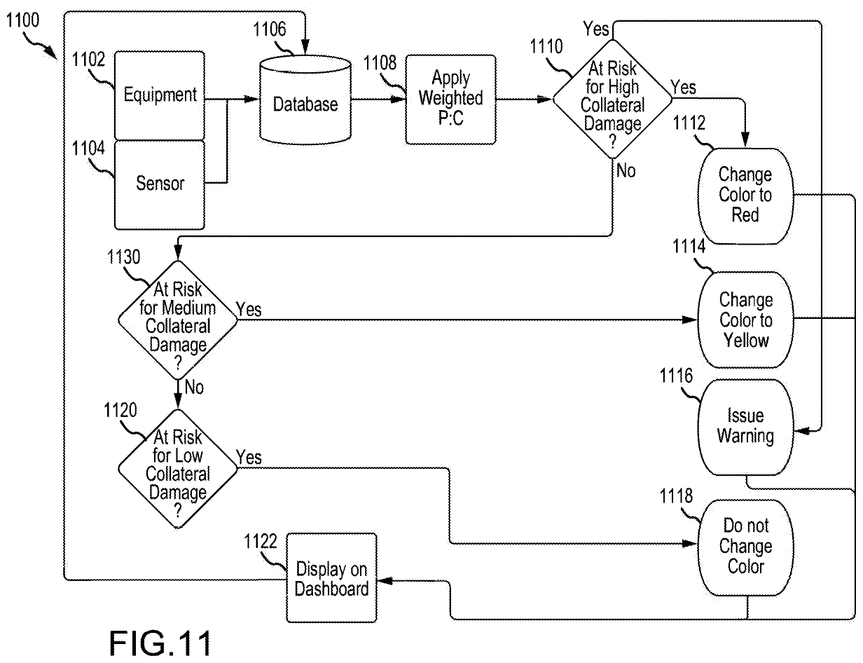

With reference to FIG. 11, method 1100 is displayed. Equipment 1102 comprises an inventory of equipment and replaceable items in a building and/or property. For example, equipment 1102 may comprise air filters, thermostats, light bulbs, fuses, carpeting, plumbing fixtures, HVAC systems, finished carpentry, valves and other rough plumbing items, and other equipment that is affixed to or otherwise associated with the building and/or property. Sensors 1104 comprise information related to the sensors as described herein with respect to system 100 and system 700. Equipment 1102 and sensors 1104 are loaded into database 1106. At apply weighted PC Ratio 1108, the weighted PC Ratios are applied to one or more buildings and/or properties. Once the PC Ratios are applied at apply weighted PC Ratios 1108, a decision point 1110 is reached. At decision point 1110, it is determined if a piece of equipment is at risk for causing a high level of collateral damage. High collateral damage is determined as a predetermined threshold for high collateral damage. For example, if a plumbing pipe ruptures, the resulting flood damage may cause extensive and expensive damage to other systems of the building and/or property if it is not mitigated immediately. If the piece of equipment is rated as having a risk of high collateral damage, then issue warning 1116 is performed. Issue warning 1116 may comprise automatically generating a message and/or other signal to indicate that there is a risk of high collateral damage for a particular piece of equipment. That warning may be displayed on a display device or may be transmitted to one or more vendor systems to initiate of repair or replacement, for example the issuance of a purchase order may be included as part of the warning that is issued at issue warning 1116. In addition, change color to red 1112 is executed. Change color to red 1112 instructs display on dashboard 1122 to highlight that equipment in red or another suitable color to indicate that there is a risk of high collateral damage. If, at decision point 1110 there is not a risk for high collateral damage, decision point 1130 is executed. At decision point 1130, it is determined if there is a risk for medium collateral damage. Medium collateral damage is determined as a predetermined threshold for medium collateral damage. If it is determined at decision point 1130 that there is a risk of medium collateral damage, then change color to yellow 1114 is executed. This feeds into display on dashboard 1122 to display that particular piece of equipment in yellow or another suitable color to indicate a risk of medium collateral damage. If decision point 1130 finds that there is not a risk of medium collateral damage, decision point 1120 is executed. Decision point 1120 determines if there is a risk for low collateral damage. Low collateral damage is determined as a predetermined threshold for collateral damage that is neither high nor low. If there is a risk for low collateral damage, do not change color 1118 is executed. This is fed into display and dashboard 1022, which does not change the color of the piece of equipment on the dashboard. As described above, the dashboard may be on a display device and the output of this these processes may update the color of that display device.

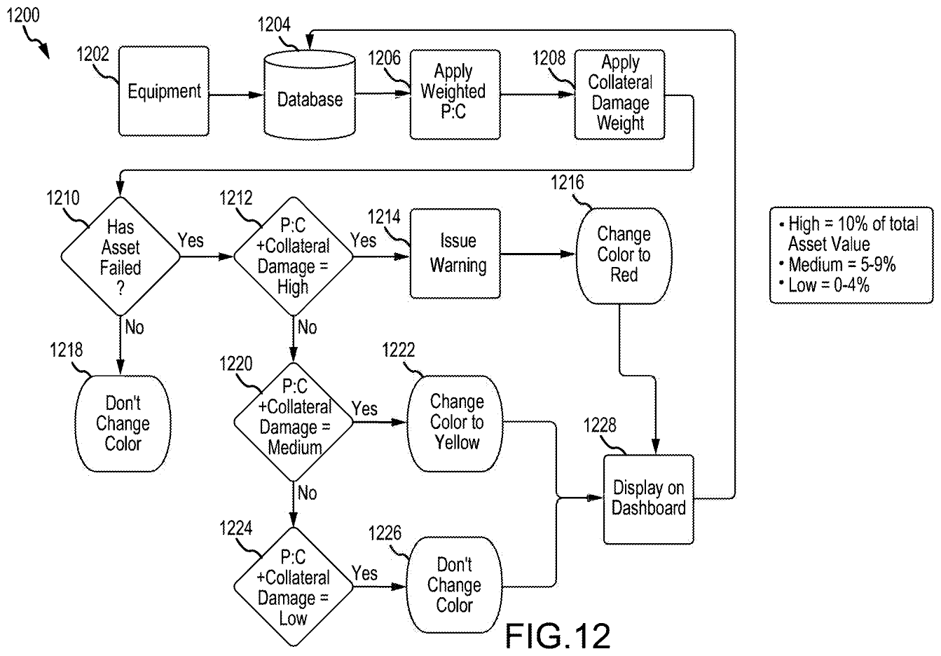

With reference to FIG. 12, method 1200 is displayed. Equipment 1202 comprises an inventory of equipment and replaceable items in a building and/or property. For example, equipment 1202 may comprise air filters, thermostats, light bulbs, fuses, carpeting, plumbing fixtures, HVAC systems, finished carpentry, valves and other rough plumbing items, and other equipment that is affixed to or otherwise associated with the building and/or property. Equipment 1202 is fed into database 1204. At apply weighted PC Ratio 1206, the weighted PC Ratios are applied to the equipment in database 1204. At apply collateral damage weight 1208, the potential collateral damage weights are applied in addition to the PC Ratio at apply weighted PC Ratio 1206. Decision point 1210 comprises a decision as to whether the asset (e.g., equipment) has failed. Failure may be determined in a predetermined failure mode that is mapped to the particular piece of equipment. Multiple failure modes may be associated with a single piece of equipment. If the asset has failed, decision point 1212 is encountered. If the PC Ratio and collateral damage is high, issue warning 1214 occurs. Issue warning 1214 may comprise changing a display on a display device to indicate that the PC Ratio and collateral damage is high. Also in response to PC Ratio collateral damage being high, change color to red 1216 occurs. At change color to red 1216, the display on dashboard 1228 is updated to display the particular piece of equipment in red or another suitable color to indicate that the PC Ratio and collateral damage is high. If the decision point 1212 finds that the PC Ratio and collateral damage is not high, then decision point 1220 is encountered. Decision point 1220 determines whether the PC Ratio and collateral damage is medium. If the PC Ratio in collateral damage is medium, change color to yellow 1222 occurs. At change color to yellow 1222, display on dashboard 1228 is updated to reflect the particular piece of equipment being yellow, or another color that is suitable to convey that the piece of equipment has a PC Ratio and collateral damage of medium. If the PC Ratio and collateral damage is found not to be medium at decision point 1220, decision point 1224 is encountered. Decision point 1224 comprises determining whether the PC Ratio and collateral damage is low. If the PC Ratio and collateral damage is low, do not change color 1226 occurs. Do not change color 1226 comprises instructing display on dashboard 1228 to not change the color associated with the particular piece of equipment so it indicates that the equipment has a PC Ratio and collateral damage of low. Although in various embodiments the predetermined values of high, medium, and low PC Ratio and collateral damage may be used, in various embodiments, high PC Ratio and collateral damage would be equal to 10% of total asset value or higher, medium PC ratio and collateral damage may be equal to between 5% and 9% of total asset value, and low PC ratio and collateral damage maybe equal to less than 4% of an asset's total value.

With reference to FIG. 1300, method 1300 is displayed. Equipment 1302 comprises an inventory of equipment and replaceable items in a building and/or property. For example, equipment 1302 may comprise air filters, thermostats, light bulbs, fuses, carpeting, plumbing fixtures, HVAC systems, finished carpentry, valves and other rough plumbing items, and other equipment that is affixed to or otherwise associated with the building and/or property. Equipment 1302 is fed into database 1304. PC Ratio weight of equipment 1306 is performed to apply PC Ratio to each piece of equipment in database 1304. Then, collateral weight 1308 is applied. Decision point 1310 is then reached. At decision point 1310, has preventative maintenance been performed is determined. If, at decision point 1310, it is determined that preventative maintenance has been performed, then do not change color 1312 is encountered. Do not change color 1312 instructs display on dashboard 1322 to not change the color of a display to indicate that a piece of equipment has had preventative maintenance performed. If, at decision point 1310, it is determined that preventative maintenance has not been performed decision point 1314 is encountered. At decision point 1314, it is determined if preventative maintenance has been performed within one week of a due date. The due date may be a predetermined date. Moreover the within one week may be also be within one month or within two months, or withing time period shorter than two months. If it is determined at decision point 1314 that preventative maintenance has been performed within one week of the due date, do not change color 1316 is encountered. Do not change color 1316 instructs displaying dashboard 1322 to not change the color associated with the piece of equipment to indicate that the piece of equipment has had preventative maintenance performed within one week of a due date. If it is determined that a piece of equipment has not had prevented a maintenance performed within one week of the due date decision point 1318 is encountered. At decision point 1318, it is determined whether preventive maintenance is late by at least one week. If it is determined at decision point 1318 that preventative maintenance is late by at least one week, then change color to yellow 1320 is encountered. Change color to yellow 1320 instructs display on dashboard 1322 to display the piece of equipment in yellow or another color suitable to determine that preventive maintenance is late by at least one week. At decision point 1318, if it is determined that preventive maintenance is late by at least one week, then decision point 1324 is encountered. At decision point 1324, it is determined whether preventive maintenance has been performed in the last six months. If it is determined that no preventative maintenance has been performed in the last six months, change color to red 1326 is encountered. Change color to red 1326 instructs display on dashboard 1322 to display the piece of equipment in red or another color suitable to indicate that preventative maintenance has not been performed in the last six months. In this manner the dashboard, which as described herein may be displayed on display device, indicates in a readably accessible manner the preventative maintenance status of various pieces of equipment associated with the building and or property. Moreover, the dashboard may automatically generate purchase orders to one or more vendor systems to initiate preventative maintenance from being performed on the one or more pieces of equipment that are displayed on the dashboard period.

With reference to FIG. 1400, method 1400 is displayed. Equipment 1402 comprises an inventory of equipment and replaceable items in a building and/or property. For example, equipment 1502 may comprise air filters, thermostats, light bulbs, fuses, carpeting, plumbing fixtures, HVAC systems, finished carpentry, valves and other rough plumbing items, and other equipment that is affixed to or otherwise associated with the building and/or property. Equipment 1402 is fed into database 1410. Sensors 1404 comprise the sensors described here and above in connection with system 100, and system 700. Data from sensors 1406 is merged with third party database 1408. Third party database 1408 comprises data from sensors that are associated with third parties. For example, third parties may provide video surveillance cloud monitoring services, thermostat monitoring services, home assistant data services, and other services that originate from the building and/or property and are stored by a third-party provider, for example in a cloud environment. Database 1410 thus aggregates data from sensors 1404, equipment 1402, and third-party database 1408. Machine learning 1412 is then applied to data in database 1410. Machine learning 1412 may comprise one or more artificial intelligence operations including use of neural networks and/or deep learning to analyze data in database 1410. At decision point 1414 and a normal or abnormal status is determined based upon the machine learning algorithms applied in machine learning 1412. For normal operation or a normal status at decision point 1414, typical operations continue. If there is an abnormality identified at decision point 1414 then decision port 1416 is encountered. Decision point 1416 determines whether there is a risk to life and or other emergency that risks high property value damage. If so, issue alert 1418 is encountered. Issue alert 1418 may comprise notifying one or more display devices or other devices that a risk to life or an emergency that has a risk of high property damage is present. For example, the alert may be a text message, an e-mail, an alert on a mobile app, an alert on a web page, an audible alarm, a visual alarm such as a flashing light, or other type of alert. Issue alert 1418 may further comprise notifying automatically various emergency services and first responders. For example, in response to a fire condition detected, issue alert 1418 may automatically notify the fire department and/or emergency medical technicians. If decision point 1416 finds that there is no risk to life and or an emergency that has a risk of high property damage, PC Ratio assessment 1424 is performed. PC Ratio assessment 1424 is performed in accordance with the methods disclosed herein. If a low risk assessment is determined then do not change color 1420 is encountered. Do not change color 1420 leads to display on the dashboard 1428. Display on dashboard 1428 would then not change the color on a dashboard. If, at decision point 1424 the PC Ratio assessment determines the medium risk then change color to yellow 1422 is encountered. Change color to yellow 1422 leads to display on dashboard 1428 which causes the display of the dashboard to indicate a color yellow or other suitable color to indicate a medium risk assessment. At decision point 1424, if there is a high-risk assessment, change color to red 1426 encountered. Change color to red 1426 leads to display and dashboard 1428. Displaying dashboard 1428 would then change a color on the display device to red or another color suitable to indicate a high-risk assessment.

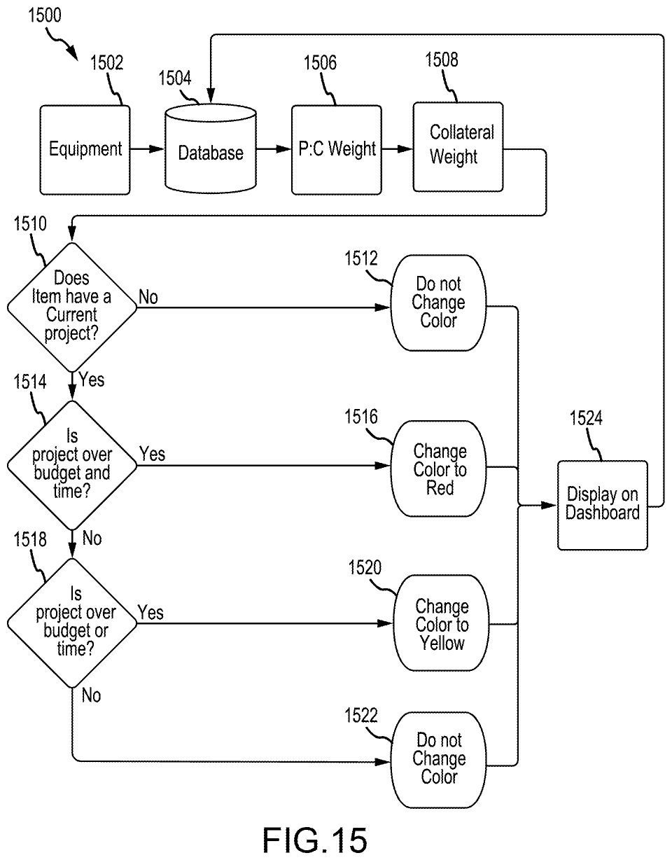

With reference to FIG. 15A, method 1500 is displayed. Equipment 1502 comprises an inventory of equipment and replaceable items in a building and/or property. For example, equipment 1502 may comprise air filters, thermostats, light bulbs, fuses, carpeting, plumbing fixtures, HVAC systems, finished carpentry, valves and other rough plumbing items, and other equipment that is affixed to or otherwise associated with the building and/or property. Equipment 1502 is fed into database 1504. PC Ratio weight of equipment 1506 is performed to apply PC Ratio to each piece of equipment in database 1504. Then, collateral weight 1508 is applied. Decision point 1510 is then reached. At decision point 1510 it is determined if a piece of equipment has a current project. If a piece of equipment does not have a current project, do not change color 1512 is encountered. Do not change color 1512 instructs display on dashboard 1524 to not change the display color on a display device related to or associated with the piece of equipment. If, at decision point 1510, an item does have a current project then decision point 1514 is encountered. At decision point 1514, it is determined whether the project is over time and budget. If the project is over time and budget, then change color to red 1516 is encountered. Change color to red 1516 instructs display on dashboard 1524 to display an indicator associated with the piece of equipment to be read or another suitable color that indicates that a project is overtime in budget. If, at decision point 1514, a project is determined not to be over time and budget, decision point 1518 is encountered. At decision point 1518 it is determined if the project is overtime or budget. If the project is overtime or budget then change color to yellow 1520 is encountered. Change color to yellow 1520 instructs display on dashboard 1524 to change color of an indicator associated with the piece of equipment to be yellow or another suitable color to indicate that a project is over time or budget period. If it is determined that the project is not over time or budget then do not change color 1522 is encountered. Do not change color 1522 instructs display on dashboard 1524 to not change the color of an indicator associated with the particular piece of equipment.

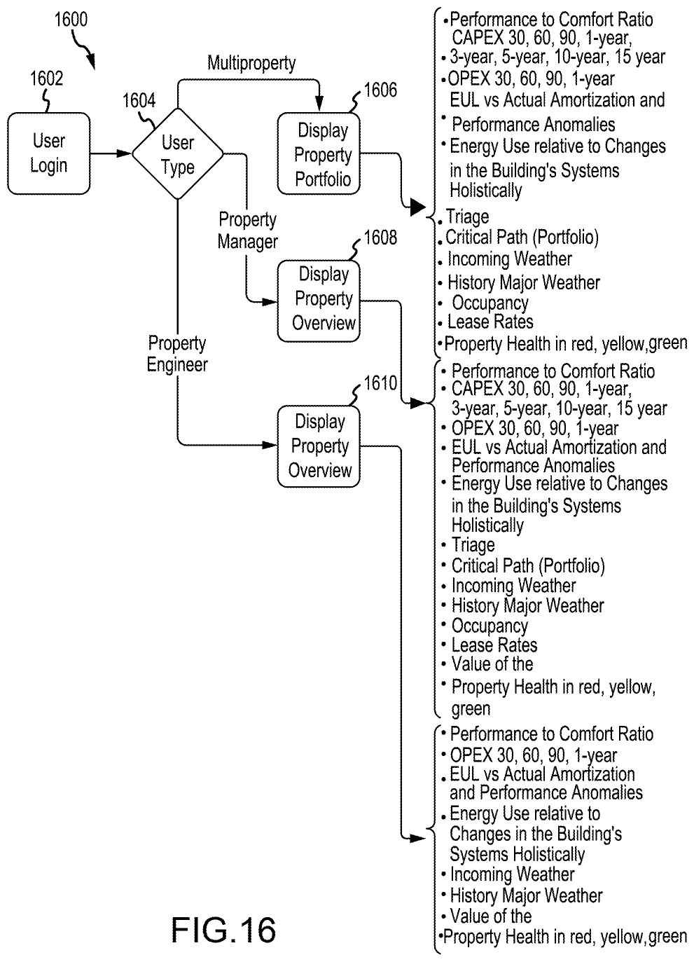

With reference to FIG. 16, method 1600 is illustrated. Method 1600 comprises an interface methodology for different personnel to view relevant information about a building or property. At user login 1602, a user enters login credentials. The login credentials are associated with that individual's job function. For example, a job function or user type may be a property engineer, a property manager, and or a multi property owner. At decision point 1604, user type is determined. At decision point 1604, if it is determined that a property engineer has logged in, display property overview 1610 is displayed. Display property overview 1610 displays information relative to a building or property that is relevant to a property engineer's job function. A property engineer typically is in charge of overseeing and or performing maintenance upgrades and other improvements to a building or property. If, at decision point 1604, it is determined that a property manager has logged in, display property overview 1608 is encountered. Display property overview 1608 displays information relevant to a property manager. The property manager is typically involved in occupant relations and other tenant management issues. The property manager may display property overview 1608 which comprises items that are relevant to the tenant management function. If, at decision point 1604 it is determined that a multi property owner has logged in, display property portfolio 1606 is displayed. Display property portfolio 1606 displays information that is relevant to a multi property owner. A multi property owner may own a variety of buildings and/or properties for investment purposes. Display property portfolio 1606 thus aggregates information that is useful to an owner to protect and grow the investment in the multiple properties and/or buildings. A list of these potential items is displayed in FIG. 16.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and communicative changes may be made without departing from the spirit and scope of the disclosure. Thus, the detailed description herein is presented for purposes of illustration only and not of limitation. For example, the steps recited in any of the method or process descriptions may be executed in any suitable order and are not limited to the order presented. Moreover, certain of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example data in database module 214. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via any suitable method, for example a software enabled link, wherein the link may be sent via an email, text, post, social network input, and/or any other method known in the art.

The process flows and screenshots depicted in the figures are merely embodiments and are not intended to limit the scope of the disclosure. For example, the steps recited in any of the method or process descriptions may be executed in any suitable order and are not limited to the order presented. It will be appreciated that the following description makes appropriate references not only to the steps and user interface elements depicted in the figures, but also to the various system components as described above with reference to FIG. 1. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

Computer programs (also referred to as computer control logic) may be stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware state machine so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid-state storage devices, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, Windows mobile, Android, Apple iOS, Blackberry, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language, for example such as C, C++, C #, Java, Javascript, Javascript Object Notation (JSON), VB Script, Macromedia Cold Fusion, Cobol, active server pages, Perl, assembly, PHP, awk, Python, Visual Basic, SQL Stored Procedures, PL/SQL, any Unix shell script, and/or extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as Javascript, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows applications, webpages, websites, web forms, prompts, etc. Practitioners will appreciate that the illustrated steps described herein may comprise, in any number of configurations, including the use of windows applications, webpages, web forms, popup windows applications, prompts, and the like. It should be further appreciated that the multiple steps as illustrated and described may be combined into single webpages and/or windows applications but have been expanded for the sake of simplicity. In other cases, steps illustrated and described as single process steps may be separated into multiple webpages and/or applications but have been combined for simplicity.

In various embodiments, the software elements of the system may also be implemented using a Javascript run-time environment configured to execute Javascript code outside of a web browser. For example, the software elements of the system may also be implemented using Node.js components. Node.js programs may implement several modules to handle various core functionalities. For example, a package management module, such as NPM, may be implemented as an open source library to aid in organizing the installation and management of third-party Node.js programs. Node.js programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. Web Sphere MQTM (formerly MQSeries) by IBM, Inc. (Armonk, N.Y.) is an example of a commercially available middleware product. An Enterprise Service Bus (“ESB”) application is another example of middleware.

The computers discussed herein may provide a suitable website or other internet-based graphical user interface which is accessible by users. In one embodiment, Microsoft company's Internet Information Services (IIS), Transaction Server (MTS) service, and an SQL Server database, are used in conjunction with Microsoft operating systems, Windows web server software, and Microsoft Commerce Server. Additionally, components such as Access software, SQL Server database, Oracle software, Sybase software, Informix software, MySQL software, Interbase software, etc., may be used to provide an Active Data Object (ADO) compliant database management system. In one embodiment, the Apache web server is used in conjunction with a Linux operating system, a MySQL database, and Perl, PHP, Ruby, and/or Python programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows, Linux, Unix, Solaris, MacOS, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, cross-over bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

In various embodiments, the server may include application servers (e.g., Websphere, Weblogic, jBoss, Postgres Plus Advanced Server, etc.). In various embodiments, the server may include web servers (e.g., Apache, IIS, Google Web Server, and/or the like).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system as well as various conventional support software and drivers typically associated with computers. The web-client may also run Microsoft Edge, Internet Explorer, Mozilla Firefox, Google Chrome, Apple Safari, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, Javascript programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (e.g., 192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM (Armonk, N.Y.), various database products available from Oracle Corporation (Redwood Shores, Calif.), Microsoft Access or SQ1 Server by Microsoft Corporation (Redmond, Wash.), MySQL by MySQL AB (Uppsala, Sweden), MongoDB, Redis, Apache Cassandra, hBase by Apache, MapR-DB by the MAPR corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, instrument, contract details, issuer, buyer, seller, user, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant, smartphone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, AppleTalk, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The disclosure and claims do not describe only a particular outcome of a system for predictive holistic facility management, but the disclosure and claims include specific rules for implementing the outcome of the predictive holistic facility management and associated process that render information into a specific format that is then used and applied to create the desired results of the predictive holistic facility management system, as set forth in McRO, Inc. v. Bandai Namco Games America Inc. (Fed. Cir. case number 15-1080, Sep. 13, 2016). In other words, the outcome of the predictive holistic facility management system can be performed by many different types of rules and combinations of rules, and this disclosure includes various embodiments with specific rules. While the absence of complete preemption may not guarantee that a claim is eligible, the disclosure does not sufficiently preempt the field of predictive holistic facility management systems at all. The disclosure acts to narrow, confine, and otherwise tie down the disclosure so as not to cover the general abstract idea of just a predictive holistic facility management system. Significantly, other systems and methods exist for predictive holistic facility management systems, so it would be inappropriate to assert that the claimed invention preempts the field or monopolizes the basic tools of predictive holistic facility management systems. In other words, the disclosure will not prevent others from providing predictive holistic facility management systems, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or to just “apply it” to an abstract process. The disclosure and claims may also be directed to improvements to software with a specific implementation of a solution to a problem in the software arts.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

A blockchain network may be a peer-to-peer network that is private, federated, and/or public in nature (e.g., the ETHEREUM® system, the Bitcoin system, the HYPERLEDGER® Fabric system, etc.). Federated and private networks may offer improved control over the content of the blockchain and public networks may leverage the cumulative computing power of the network to improve security. A blockchain network may comprise various blockchain nodes (e.g., consensus participants) in electronic communication with each other, as discussed further herein. Each blockchain node may comprise a computing device configured to write blocks to the blockchain and validate blocks of the blockchain. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., an IPHONE® device, a BLACKBERRY® device, an ANDROID® device, etc.), tablets, wearables (e.g., smart watches and smart glasses), Internet of Things (IOT) devices, or any other device capable of receiving data over network. Each computing device may run applications to interact with the blockchain network, communicate with other devices, perform crypto operations, and otherwise operate within systems 100 and 700. Computing devices may run a client application that can be a thin client (web), hybrid (i.e. web and native, such as iOS and ANDROID® systems), or native application to make API calls to interact with the blockchain, such as a web3 API compatible with blockchain databases maintained by the ETHEREUM® system.

The blockchain may be based on any blockchain technology such as, for example, ETHEREUM®, OPENCHAIN®, Chain Open Standard technology, HYPERLEDGER® Fabric, CORDA®, Connect™, Sawtooth™, etc. The blockchain may comprise a system of blocks containing data that are interconnected by reference to the previous block. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. When implemented in support of systems 100 and 700, the blockchain may serve as an immutable log for transactions and related contracts and processes, such as maintenance history, equipment replacement history, tenant/occupant activity data, and the like.

A blockchain address may be uniquely assigned to each blockchain node or participant to function as a unique identifier for each participant in blockchain network 101. For example, each participant may register with blockchain network 101, and/or an existing trust participant (e.g., identity provider), and may be assigned and provided a private key and public key pair. In various embodiments, blockchain network 101 may use a Hierarchical Deterministic (HD) solution to enable the creation of one or more child keys from one or more parents keys in a hierarchy. Each child key may be assigned to a participant in blockchain network 101. For example, blockchain network 101 may use BIP32, BIP39, and/or BIP44 to generate an HD tree of public addresses.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for predictive holistic facility management comprising:
a sensor in electronic communication with a processor;
a non-transitory computer-readable storage medium in electronic communication with the processor having instructions stored thereon that, in response to execution by the processor, cause the processor to perform operations comprising:
receiving, at the processor, first data related to a building from the sensor;
receiving, at the processor, second data related to a state of the building;
calculating, by the processor, a PC Ratio of the building based upon the first data and the second data;
allocating, by the processor, a predetermined capital expenditure and operating expenditure budget to the building based upon the PC Ratio.

2. The system for predictive holistic facility management of claim 1, wherein the instructions further comprise:
sending, by the processor, a dashboard report based upon the PC Ratio to a display device.

3. The system for predictive holistic facility management of claim 2, wherein the second data comprises data related to construction and prior maintenance history of the building.

4. The system for predictive holistic facility management of claim 2, wherein the instructions further include calculating, by the processor, a risk of collateral damage of a system failure for a system associated with the building.

5. The system for predictive holistic facility management of claim 2, wherein the instructions further include determining, by the processor, whether a system associated with the building is below 10% of its estimated useful life.

6. The system for predictive holistic facility management of claim 2, wherein the instructions further include issuing, by the processor, a warning based upon the PC Ratio and risk of collateral damage being above a predetermined threshold.

7. The system for predictive holistic facility management of claim 2, wherein the instructions further include issuing, by the processor, a warning based upon finding a condition that is a risk to life.

8. An article of manufacture including a tangible, non-transitory computer-readable storage medium in electronic communication with a processor system, having instructions stored thereon that, in response to execution by a processor, cause the processor to perform operations comprising:
receiving, at the processor, first data related to a building from a sensor;
receiving, at the processor, second data related to a state of the building;
calculating, by the processor, a PC Ratio of the building based upon the first data and the second data;
allocating, by the processor, a predetermined capital expenditure and operating expenditure budget to the building based upon the PC Ratio.

9. The article of manufacture of claim 8, wherein the instructions further comprise:
sending, by the processor, a dashboard report based upon the PC Ratio to a display device.

10. The article of manufacture of claim 9, wherein the second data comprises data related to construction and prior maintenance history of the building.

11. The article of manufacture of claim 9, wherein the instructions further include calculating, by the processor, a risk of collateral damage of a system failure for a system associated with the building.

12. The article of manufacture of claim 9, wherein the instructions further include determining, by the processor, whether a system associated with the building is below 10% of its estimated useful life.

13. The article of manufacture of claim 9, wherein the instructions further include issuing, by the processor, a warning based upon the PC Ratio and risk of collateral damage being above a predetermined threshold.

14. The article of manufacture of claim 9, wherein the instructions further include issuing, by the processor, a warning based upon finding a condition that is a risk to life.

15. A method for predictive holistic facility management comprising:
receiving, at a processor, first data related to a building from a sensor;
receiving, at the processor, second data related to a state of the building;
calculating, by the processor, a PC Ratio of the building based upon the first data and the second data;
allocating, by the processor, a predetermined capital expenditure and operating expenditure budget to the building based upon the PC Ratio.

16. The method of claim 15, further comprising sending, by the processor, a dashboard report based upon the PC Ratio to a display device.

17. The method of claim 16, wherein the second data comprises data related to construction and prior maintenance history of the building.

18. The method of claim 16, further comprising calculating, by the processor, a risk of collateral damage of a system failure for a system associated with the building.

19. The method of claim 16, further comprising determining, by the processor, whether a system associated with the building is below 10% of its estimated useful life.

20. The method of claim 16, further comprising issuing, by the processor, a warning based upon the PC Ratio and risk of collateral damage being above a predetermined threshold.
